(19) United States
(12) Patent Application Publication
(10) Pub. No.: US 2013/0343099 A1
(43) Pub. Date: Dec. 26, 2013

(54) ACTIVE DAMPING CIRCUIT, ACTIVE DAMPING METHOD, POWER SUPPLY DEVICE COMPRISING THE ACTIVE DAMPING CIRCUIT

(71) Applicant: FAIRCHILD KOREA SEMICONDUCTOR LTD., Bucheon (KR)

(72) Inventors: Hyun-Chul EOM, Seoul (KR); Yong-Sang SHIN, Bucheon-si (KR)

(21) Appl. No.: 13/922,410

(22) Filed: Jun. 20, 2013

Related U.S. Application Data
(60) Provisional application No. 61/662,514, filed on Jun. 21, 2012.

(30) Foreign Application Priority Data
May 23, 2013 (KR) 10-2013-0058578

(51) Int. Cl. H02M 3/335

(52) U.S. Cl. CPC H02M 3/33569
USPC 363/21.12

(57) ABSTRACT

An active damping circuit according to an exemplary embodiment of the present invention is applied to a power supply using an input voltage that is generated by rectifying an AC input passed through a dimmer. The active damping circuit includes: an active damper including a damper resistor coupled to the input voltage and a damper switch coupled in parallel with the damper resistor; and an active damping controller controlling a switching operation of the damper switch using a high voltage switch that generates a predetermined power voltage to control a resistance value of the active damper of a firing period of the input voltage to be higher than a resistance value of the active damper of other periods, excluding at least the firing period among a period during which the input voltage is generated.

### CROSS-REFERENCE TO RELATED APPLICATION

This application claims priority to and the benefit of U.S. Patent Application No. 61/662,514 filed in the USPTO on Jun. 21, 2012, and priority to and the benefit of Korean Patent Application No. 10-2013-0058578, filed with the Korean Intellectual Property Office on May 23, 2013, the entire contents of which are incorporated herein by reference.

### BACKGROUND OF THE INVENTION

(a) Field of the Invention

The content disclosed in the present specification relates to an active damping circuit, an active damping method, and a power supply including an active damping circuit.

(b) Description of the Related Art

A damping resistor is used to reduce a spike current that is generated when an input capacitor is charged by an input voltage.

In further detail, the input capacitor is disposed in the next terminal of a rectification terminal (e.g., a bridge diode) that rectifies an AC input passed through a dimmer. The AC input passed through the dimmer is passed through the rectification such that the input voltage is generated.

A portion of the AC input, included in a dimming angle is passed and other portions, excluded from the dimming angle of the AC input are cut off. A dimming angle start time, the AC input is suddenly increased or suddenly decreased. The input voltage rectified from the AC input passed through the dimmer is also suddenly increased or suddenly decreased at the dimming angle start time.

Particularly, a rapid increase of the input voltage at the dimming angle start time is called firing. At a fire time, a spike current that charges the input capacitor is generated. A period during which the spike current is generated is called a firing period.

A conventional damping resistor is useful during the firing period because it reduces the spike current, but causes unnecessary power consumption after termination of the firing period.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention has been made in an effort to provide an active damping circuit that can control a damping resistor, an active damping method, and a power supply including the active damping circuit.

An exemplary embodiment of the present invention relates to an active damping method using an active damper that includes a damper resistor coupled to an input voltage and a damper switch coupled in parallel with the damper resistor. The active damping method includes detecting fire of the input voltage and turning off a damper switching during at least a firing period of the input voltage. The active damper is coupled to a high voltage switch generating a power voltage using the input voltage.

An active damping circuit according to an exemplary embodiment of the present invention is applied to a power supply using an input voltage that is generated by rectifying an AC input passed through a dimmer.

The active damping circuit includes: an active damper including a damper resistor coupled to the input voltage and a damper switch coupled in parallel with the damper resistor; and an active damping controller controlling a switching operation of the damper switch using a high voltage switch that generates a predetermined power voltage to control a resistance value of the active damper of a firing period of the input voltage to be higher than a resistance value of the active damper of other periods, excluding at least the firing period among a period during which the input voltage is generated.

A control electrode of the damper switch is coupled to a first electrode of the high voltage switch.

The active damper further includes a first resistor coupled between a first terminal of the damper resistor and the control electrode of the damper switch and a first diode including an anode coupled to a second terminal of the damper resistor and a cathode coupled between control electrodes of the damper switch.

The active damping controller turns off the damper switch during the at least firing period and turns on the damper switch after termination of the at least firing period among the period during which the input voltage is generated.

The active damping controller includes a delay unit delaying an input detection signal that indicates a generation period of the input voltage for a predetermined delay period and a control switch coupled to a second electrode of the high voltage switch, and when the power voltage is higher than a predetermined low voltage reference, the active damping controller controls turn-on/off of the control switch according to an output of the delay unit.

The active damping controller further includes: an inverter inverting an output signal that indicates whether the power voltage is higher than the predetermined low voltage reference; a first logic gate outputting a result of an OR operation performed on an output of the delay unit and the input detection signal; and a second logic gate generating an output that controls a switching operation of the control switch by performing an AND operation on an output of the inverter and an output of the first logic gate.

The predetermined delay period includes the at least firing period.

An active damping method according to another exemplary embodiment of the present invention includes: detecting a generation period of an input voltage using an auxiliary voltage generated from an auxiliary coil coupled with a predetermined turn ratio with a first coil coupled to the input voltage; determining whether a power voltage required for controlling a switching operation of a power switch coupled to the first coil is higher than a predetermined level; controlling the active damper with a second resistance value by turning on the damper switch after the at least firing period among the generation period of the input voltage when the power voltage is higher than the predetermined level.

The detecting the generation period of the input voltage input voltage includes: supplying a source current to the auxiliary coil during a turn-on period of the power switch coupled to the first coil; generating an input sense voltage using the source current; and generating an input detection signal that indicates the generation period of the input voltage according to a result of comparison between a sampling voltage generated by sampling the input sense voltage and a predetermined reference voltage.

The controlling the active damper with the first resistance value comprises a period during which the input detection signal and an input detection signal delayed by a predetermined period are different from each other among the generation period of the input voltage. The predetermined period corresponds to the at least firing period.

When the power voltage is lower than the predetermined level, the active damping method further includes controlling the active damper with the first resistance value. The first resistance value is higher than the second resistance value.

A power switch according to another exemplary embodiment of the present invention includes: an active damper including a damper resistor coupled to an input voltage generated by rectifying an AC input passed through a dimmer and a damper switch coupled in parallel with the damper resistor; a first coil including a first terminal coupled to the active damper; a power switch coupled to a second terminal of the first coil; an auxiliary coil coupled with a turn ratio to the first coil; and an active damping controller sensing a generation period of the input voltage using an auxiliary voltage generated in the auxiliary coil and controlling a switching operation of the damper switch using a high voltage switch required for controlling of the switching operation of the power switch to control a resistance value of the active damper of a firing period of the input voltage to be higher than a resistance value of the active damper of other periods, excluding at least the firing period among the generation period of the input voltage.

The power supply further includes: a capacitor charged with the power voltage; a switch coupled between the capacitor and a second electrode of the high voltage switch; and a control switch including a first terminal coupled to the second electrode of the high voltage switch. The control switch is turned on during the at least firing period among the generation period of the input voltage.

The power supply further includes a low voltage comparator comparing the power voltage with a predetermined low voltage reference, and the switch performs a switching operation according to an output of the low voltage comparator.

The power supply further includes a comparator comparing the power voltage and a predetermined minimum voltage, and the switch performs a switching operation according to the output of the low voltage comparator and an output of the comparator. The switch is turned on when the power voltage is lower than the low voltage reference or when the power voltage is lower than the predetermined minimum voltage.

According to the exemplary embodiments of the present invention, an active damping circuit that can control a damping resistor, an active damping method, and a power supply including the active damping circuit can be provided.

### BRIEF DESCRIPTION OF THE DRAWINGS

FIG. 1 shows a power supply to which an active damper and an active damping controller are applied according to an exemplary embodiment of the present invention.

FIG. 2 shows a switch control circuit according to the exemplary embodiment of the present invention.

FIG. 3 is a waveform diagram illustrating an input voltage, an input detection signal and outputs of the active damping controller according to the exemplary embodiment of the present invention.

FIG. 4 shows a switch control circuit according to another exemplary embodiment of the present invention.

FIG. 5 is a waveform diagram of a power voltage and an output of an OR gate according to the other exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

In order to solve the above-stated problem, the damping resistor should be controlled to have a low resistance value during an input voltage generation period, excluding a firing period. An active damper according to an exemplary embodiment of the present invention is operated with high resistance during at least a firing period, and is operated with low resistance, e.g., resistance close to zero, during an input voltage generation period, excluding a firing period.

An active damper control means according to an exemplary embodiment of the present invention is coupled to an output terminal of a high voltage switch that is coupled to a start-up pin. In addition, the active damper is coupled to an input terminal of the high voltage switch through the start-up pin.

The high voltage switch generates a current that controls a power voltage VDD required for operation of a switch control circuit using the input voltage transmitted through the start-up pin. The switch control circuit controls a switching operation of a switch (hereinafter, referred to as a power switch) of the power supply.

An input sense voltage that depends on the input voltage is generated using a voltage of an auxiliary coil coupled to a primary side first coil of the power supply, and a firing time of the input voltage is determined using the input sense voltage. An input detection signal fluctuated by being synchronized at the firing time is transmitted to an active damping controller. The active damping controller is synchronized by the input detection signal and controls an active damper with high resistance during at least a firing period, and controls the active damper with low resistance during other periods of the input voltage generation period, excluding the at least firing period.

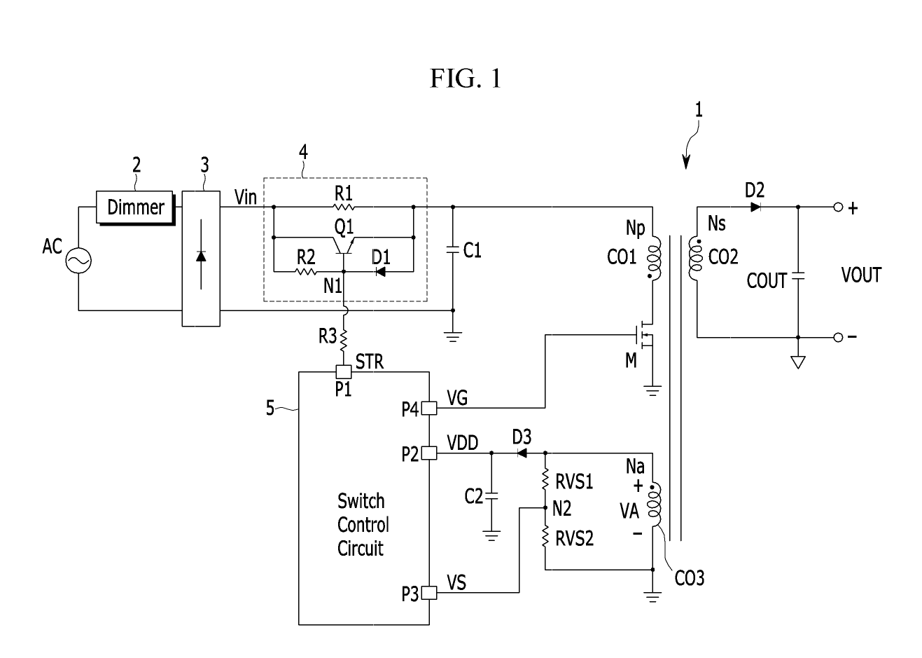

Hereinafter, an exemplary embodiment of the present invention will be described with reference to FIG. 1 to FIG. 5.

FIG. 1 shows a power supply to which an active damper and an active damping controller are applied according to an exemplary embodiment of the present invention.

A power supply 1 supplies power to a load using an AC input AC. The power supply according to the exemplary embodiment of the present invention is realized as a flyback converter, but the present invention is not limited thereto.

The AC input passed through a dimmer 2 is full-wave rectified by a rectification circuit 3 and then generated as an input voltage Vin. A dimming angle of the dimmer 2 determines an AC input AC that passes through the dimmer 2. For example, the AC input AC passing through the dimmer 2 is increased as the dimming angle is increased, and when the dimming angle is 180 degrees, all AC input AC pass through the dimmer 2.

The active damper 4 is operated with high resistance during a firing period and operated with low resistance during other period than the firing period. The active damper 4 includes a damper resistor R1, a resistor R2, a damper switch Q1, and a diode D1. For example, the active damper 4 is operated with resistance of the damper resistor R1 during the firing period, and is operated with zero resistance due to turn-on of the damper switch Q1 during other period than the firing period.

The damper resistor R1 is coupled between a rectification circuit 3 and an input capacitor C1. A first terminal of the damper resistor R1 is coupled to the rectification circuit 3, and a second terminal of the damper resistor R1 is coupled to the input capacitor C1 and a first coil CO1. The damper switch Q1 is coupled to lateral terminals of the damper resistor R1 in parallel. The damper switch Q1 is realized as an-n channel type bipolar junction transistor (BJT). A collector of the damper switch Q1 is coupled to the rectification circuit 3, and an emitter of the damper switch Q1 is coupled to the input capacitor C1 and the first coil CO1.

The resistor R2 is coupled between the rectification circuit 3 and a base of a damper switch Q1, and the diode D1 is coupled between the base and an emitter of the damper switch Q1. In further detail, a first terminal of the resistor R2 is coupled to the rectification circuit 3, a second terminal of the resistor R2 is coupled to the base of the damper switch Q1, an anode of the diode D1 is coupled to the emitter of the damper switch Q1, and a cathode of the diode D1 is coupled to the base of the damper switch Q1.

The first node N1 is coupled with the base of the damper switch Q1, the second terminal of the resistor R2, and the cathode of the diode D1.

The input capacitor C1 is coupled to an active damper 4, and the input voltage Vin is smoothened by the capacitor C1.

A first terminal of the first coil CO1 disposed in the primary side is coupled to the input capacitor C1 and the active damper 4. A second terminal of the first coil CO1 is coupled to the power switch M. A turn ratio (Na/Np) between turns Na of an auxiliary coil CO3 and turns Np of the first coil CO1 is called wn1. The auxiliary coil CO3 and the first coil CO1 are coupled with the turn ratio wn1.

A second coil CO2 disposed in the secondary side is coupled to an output capacitor COUT through a rectification diode D2, and a turn ratio (Na/Ns) of turns Na of the auxiliary coil CO3 and turns Ns of the second coil CO2 is called wn2. The auxiliary coil CO3 and the second coil CO2 are coupled with the turn ratio wn2.

A rectification diode D2 includes an anode coupled to the first terminal of the second coil CO2 and a cathode coupled to a second terminal of the output capacitor COUT. The output capacitor COUT is charged by a current passed through the rectification diode D2 and maintains the output voltage VOUT.

An anode of a diode D3 is coupled to the auxiliary coil CO3 and a cathode of the diode D3 is coupled to a power pin P2. The capacitor C2 is coupled between the power pin P2 and the primary side ground, and maintains a power voltage VDD. A current generated in the auxiliary coil CO3 is passed through the diode D3 such that a capacitor C2 is charged and the power voltage VDD is generated in the capacitor C2.

The power voltage VDD is a voltage required for controlling a switching operation of the power switch M, and is also required for operation of the switch control circuit 5.

A voltage of a second node N2 to which a first sense resistor RVS1 and a second sense resistor RVS2 coupled in series between lateral terminals of the auxiliary coil CO3 are connected is hereinafter referred to as a sense voltage VS. The second node N2 is coupled to a sense pin P3.

The switch control circuit 5 includes a start-up pin P1, the power pin P2, the sense pin P3, and a gate pin P4. The start-up pin P1 is coupled to the first node N1 through the resistor R3, and the gate pin P4 is coupled to a gate electrode of the power switch M.

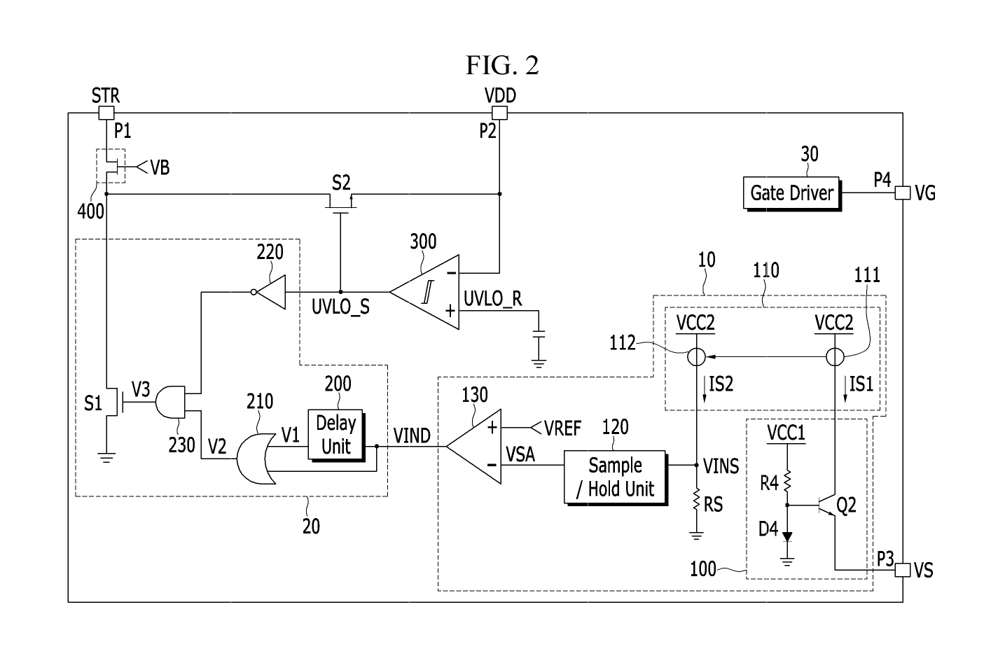

Hereinafter, the switch control circuit 5 will be described in further detail with reference to FIG. 2.

FIG. 2 shows the switch control circuit according to the exemplary embodiment of the present invention.

As shown in FIG. 2, the switch control circuit 5 includes an input voltage detection unit 10 and an active damping controller 20. The switch control circuit 5 further includes a gate driver 30, a UVLO comparator 300, a high voltage switch 400, and a switch S2.

The gate driver 30 generates a gate voltage VG that controls the switching operation of the power switch M. The gate voltage VG is transmitted to the gate electrode of the power switch M through the gate pin P4.

The high voltage switch 400 generates a current using a start voltage STR transmitted through the start-up pin P1 during a start-up period. The high voltage switch 400 may be realized as a JFET, and is driven by a bias voltage VB supplied to the gate electrode. A first electrode of the high voltage switch 400 is coupled to the start-up pin P1, and a second electrode of the high voltage switch 400 is coupled to a switch S2 and a control switch S1.

The switch S2 transmits the current of the high voltage switch 40 to a capacitor C2 through the power pin P2. The switch S2 is turned on only when the power voltage VDD is lower than a low voltage reference UVOL_R. For example, the switch S2 is in the turn-on state during the start-up period.

A drain electrode of the switch S2 is coupled to a node to which the high voltage switch 400 and the control switch S1 are coupled, a source electrode of the switch S2 is coupled to the power pin P2, and a gate electrode of the switch S2 is coupled to an output terminal of the UVLO comparator 300.

A drain electrode of the control switch S1 is coupled to a second electrode of the high voltage switch 400 and a source electrode of the control switch S1 is coupled to the ground.

The UVLO comparator 300 controls a switching operation of the switch S2 according to a result of comparison between the power voltage VDD and the low voltage reference UVOL_R. When the power voltage VDD is higher than the low voltage reference UVOL_R, the switch S2 is turned off, and in the opposite case, the switch S2 is turned on.

The UVLO comparator 300 is realized as a hysteresis comparator, and the low voltage reference UVLO_R may be a range having the lowest and highest limits. The UVLO comparator 300 includes an inverse terminal (−) to which the power voltage VDD is input and a non-inverse terminal (+) to which the low voltage reference UVOL_R is input.

The UVLO comparator 300 generates a high-level output signal UVLO_S when a decreasing power voltage VDD is lower than the lowest limit of the low voltage reference UVLO_R, and generates a low-level output signal UVLO_S when the power voltage VDD is higher than the highest limit of the low voltage reference UVLO_R.

For example, the power voltage VDD starts to increase during the start-up period. The UVLO comparator 300 generates a low-level output signal UVLO_S when the power voltage VDD is higher than the highest limit of the low voltage reference UVLO_R during the start-up period. Then, the switch S2 is turned off by the low-level output signal UVLO_S.

On the contrary, when the power voltage VDD starts to decrease from a voltage higher than the highest limit of the low voltage reference UVLO_R, the UVLO comparator 300 generates a high-level output signal UVLO_S when the power voltage VDD is lower than the lowest limit of the low voltage reference UVLO_R. Then, the switch S2 is turned on by the high-level output signal UVLO_S.

The input voltage detection unit 10 generates an input detection signal VIND that indicates a period during which the input voltage Vin is generated. The input voltage detection unit 10 generates the input detection signal VIND using the source current IS1 supplied to the auxiliary coil CO3 through the turn-on period of the power switch M. The active damping controller 20 according to the exemplary embodiment of the present invention recognizes fire by fluctuation of the input detection signal VIND.

During the turn-on period of the power switch M, the voltage of the first coil CO1 becomes the input voltage VIN, and a negative voltage (−wn1*Vin) obtained by multiplying the turn ratio wn1 to the input voltage Vin is generated as a voltage VA (hereinafter, referred to as an auxiliary voltage) of the auxiliary coil CO3. A source current IS1 that depends on a difference between a voltage of the second node N2 and the auxiliary voltage VA flows through the resistor RVS1. Here, the voltage of the second node N2 will be referred to as a sense voltage VS.

The input voltage detection unit 10 generates an input sense voltage VINS using a mirror current IS2 generated by mirroring the source current IS1, generates a sampling voltage VSA by sampling the input sense voltage VINS for every switching cycle of the power switch M, and detects fire of the input voltage Vin according to a result of comparison between the sampling voltage VSA and a reference voltage VREF.

The input voltage detection unit 10 includes a clamping circuit 100, a current mirror circuit 110, a sample/hold unit 120, a sense resistor RS, and a comparator 130.

The clamping circuit 100 clamps the sense voltage VS to zero voltage during the turn-on period of the power switch M. In further detail, the auxiliary voltage is a negative voltage during the turn-on period of the power switch M, and the source current IS1 flows to the auxiliary coil CO3 through the clamping circuit 100. In this case, the second node N2 coupled to the clamping circuit 100 and a cathode of the diode D4 have the same potential. Accordingly, the sense voltage VS is clamped to zero voltage.

Among the AC input AC, an input voltage Vin for a portion cut off by the dimmer 2 (i.e., a portion not included in the dimming angle) is zero voltage. In the portion, the auxiliary voltage VA is also zero voltage even through the power switch M1 is in the turn-on state, and therefore no current flowing to the auxiliary coil CO3 from the clamping circuit 100 is generated.

When the power switch M is turned off. The voltage of the second coil CO2 is an output voltage VOUT. The auxiliary voltage VA becomes a positive voltage obtained by multiplying the turn ratio wn2 to the voltage of the second coil CO2. Then, no current flowing to the auxiliary coil CO3 from the second node N2 is generated. That is, the source current IS1 does not flow.

As described, when the auxiliary voltage VA is zero voltage or a positive voltage, the clamping circuit 100 is not operated and the source current IS1 does not flow. The source current IS1 is generated only when the input voltage Vin exists and the power switch M is in the turn-on state according to the exemplary embodiment of the present invention.

The clamping circuit 100 includes a resistor R4, a diode D4, and a BJT Q2, and clamps the sense voltage VS to zero voltage during the turn-on period of the power switch M. The source current IS1 generated during the clamping operation of the clamping circuit 100 is determined according to the auxiliary voltage VA, and the auxiliary voltage VA depends on the input voltage Vin during the turn-on period of the power switch M so that the source current IS1 depends on the input voltage Vin.

The resistor R4 includes a first terminal to which the voltage VCC1 is input and a second terminal coupled to a base of the BJT Q2. An anode of the diode D4 is coupled to a base of the BJT Q2, and a cathode of the diode D4 is coupled to the ground. A collector of the BJT Q2 is coupled to the current mirror circuit 110 and an emitter of the BJT Q2 is coupled to the second node N2.

A base voltage of the BJT Q2 is maintained with a threshold voltage (e.g., 0.7V) of the diode D4, and a threshold voltage of the BJT Q2 is set to be equivalent to the threshold voltage of the diode D4. During the turn-on period of the power switch M, a source current IS1 flowing to the BJT Q2 is generated, and in this case, an emitter voltage of the BJT Q2 corresponds to a voltage obtained by subtracting the threshold voltage from the base voltage of the BJT Q2, and therefore the sense voltage VS is maintained with zero voltage.

The current mirror circuit 110 generates a mirror current IS2 by mirroring the source current IS1 flowing to the clamping circuit 100. The current mirror circuit 110 includes a first current source 111 and a second current source 112.

The first current source 111 is coupled between the voltage VCC2 and the BJT Q2, and supplies the source current IS1 to the clamping circuit 100 using a voltage source VCC2. The second current source 112 is coupled to the voltage VCC2, and generates the mirror current IS2 by mirroring the source current IS1 using the voltage VCC2. In the exemplary embodiment of the present invention, the source current IS1 and the mirror current IS2 are set to be equivalent to each other.

The mirror current IS2 flows to the sense resistor RS so that the sense voltage VINS is generated.

The sample/hold unit 120 samples the input sense voltage VINS for every switching cycle of the power switch M to generate a sampling voltage VSA and holds the sampling voltage VSA. For example, the sample/hold unit 120 generates the sampling voltage VSA during a turn-on period of the power switch M, and holds the sampling voltage VSA until before the next turn-on period the power switch M.

The comparator 130 generates an input detection voltage VIND according to a result of comparison between the sampling voltage VSA and a reference voltage VREF. The reference voltage VREF is a voltage for sensing fire of the input voltage Vin, and may be set to a voltage close to zero voltage.

For example, the comparator 130 includes an inverse terminal (−) to which the sampling voltage VSA is input and a non-inverse terminal (+) to which the reference voltage VREF is input, and generates a high-level input detection signal VIND when the input of the non-inverse terminal (+) is higher than the input of the inverse terminal (−) and generates a low-level input detection signal VIND when the input of the non-inverse terminal (+) is lower than the input of the inverse terminal (−). When a fire occurs in the input voltage Vin, the high-level input detection signal VIND is changed to low level.

The active damping controller 20 controls the active damper 4 with the damper resistor R1 during at least a firing period of the input voltage, and controls the active damper 4 with zero resistance after the firing period. Since the active damping controller 20 is operated when the power voltage VDD is higher than the low voltage reference UVLO_R, the active damper 4 is always operated as a resistor for a period during which the power voltage VDD is lower than the low voltage reference UVLO_R (e.g., start-up period).

The active damping controller 20 controls resistance of the active damper 4 according to the input detection signal VIND. The active damping controller 20 turns off the damper switch Q1 of the active damper 4 for a predetermined delay period from a falling edge time (i.e., an input voltage fire time) of the input detection signal VIND. Then, a resistance value of the active damper 4 is the damper resistor R1.

In addition, the active damping controller 20 turns on the damping switch Q1 after termination of the delay period for the period during which the input voltage Vin is generated. Then, the resistance value of the active damper 4 is zero.

The delay period may be set with consideration of the firing period of the input voltage Vin. For example, the delay period is set to include at least the firing period of the input voltage Vin.

The active damping controller 20 includes a delay unit 200, an OR gate 210, an inverter 220, an AND gate 230, and a control switch S1.

The control switch S1 is an n channel type transistor, and includes a gate electrode to which an output V3 is input.

The inverter 220 inverts the output signal UVLO_S. When the power voltage VDD is higher than the low voltage reference UVLO_R, the output of the inverter 220 becomes high level, and when the power voltage VDD is lower than the low voltage reference UVLO_R, the output of the inverter 220 becomes low level.

Since the output of the inverter 220 is an input of the AND gate 230, an output of the AND gate 230 becomes low level without regard to other input when the output of the inverter 220 is low level. When the output of the inverter 220 is high level, the output of the AND gate 230 is determined according to another input. That is, the AND gate 230 is activated when the power voltage VDD is higher than the low voltage reference UVLO_R.

The delay unit 200 delays the input detection signal VIND during a delay period.

The OR gate 210 performs an OR operation on an output V1 of the delay unit 200 and the input detection signal VIND, and outputs the operation result.

The AND gate 230 performs an AND operation on the output of the inverter 220 and the output V2 of the OR gate 210 to generate the output V3 that controls a switching operation of the control switch S1.

Hereinafter, a normal state refers to a state that the power voltage VDD is higher than the low voltage reference UVLO_R, and a low-voltage state refers to a state that the power voltage VDD is lower than the low voltage reference UVLO_R.

Since the switch S2 is in the turn-on state in the low-voltage state, a current of the high voltage switch 400 flows to the capacitor C2 and a current is not supplied to a base of the damper switch Q1 through the resistor R2 of the active damper 4.

Since the switch S2 is in the turn-off state in the normal state, the current of the high voltage switch 400 is controlled according to the control switch S1.

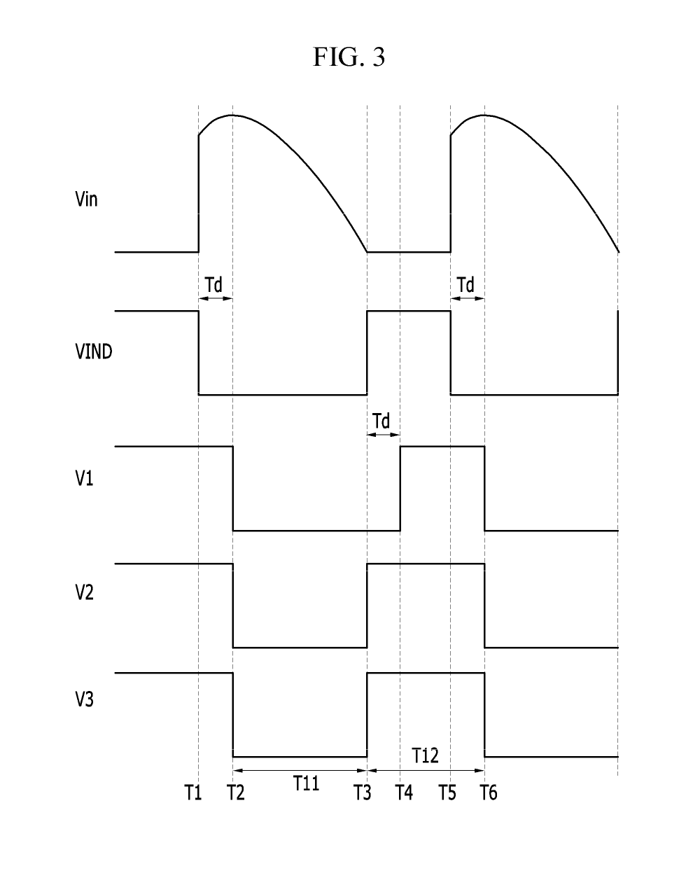

Hereinafter, operation of the active damper 4 will be described with reference to FIG. 3.

FIG. 3 is a waveform illustrating the input voltage, the input detection signal, and outputs of the active damping controller according to the exemplary embodiment of the present invention.

As shown in FIG. 3, the input voltage Vin is fired at a time T1 and the input voltage is generated during a period T1 to T3. Then, during the period T1 to T3, the sampling voltage VSA is higher than the reference voltage VREF and therefore the input detection signal VIND maintains low level.

The delay unit 200 generates the output V1 by delaying the input detection signal VIND by a delay period Td. Accordingly, the output V1 maintains low level during a period T2 to T4. Since the output of the OR gate 210 is obtained by performing OR on the input detection signal VIND and the output V1, the OR gate 210 generates a low-level output V2 during a period T11.

Then, the AND gate 230 generates a low-level output V3 during the period T11. The control switch S1 is turned off during the period T11, and the current of the high voltage switch 400 does not flow. Then, the current flows to the base of the damper switch Q1 through the resistor R2 from the input voltage Vin, and thus the damper switch Q1 is turned on. Then, lateral ends of the active damper 4(i.e., the first terminal coupled to the rectification circuit 3 and the second terminal coupled to the input capacitor C1) are coupled through the damper switch Q1. That is, the resistance value of the active damper 4 is zero.

At a time T3, when the input voltage Vin becomes zero voltage, the sense voltage VS becomes zero voltage and the sampling voltage VSA also becomes zero voltage. Then, the input detection signal VIND becomes high level so that the output V2 of the OR gate 210 becomes high level and the output V3 of the AND gate 230 also becomes high level. Thus, at the time T3, the control switch S1 is turned on.

After the time T3, the current of the high voltage switch 400 turns on the control switch S1 so that the first node N1 is coupled to the primary side ground. Thus, no current is supplied to the base of the damper switch Q1 and the damper switch Q1 is turned off. After the time T3, the active damper 4 is operated as a damper resistor R1.

At a time T5, the input voltage Vin is fired, and the control switch S1 is turned off again at a time T6 that is a time after a delay period Td from the time T5. Then, the active damper 4 has zero resistance again.

According to the exemplary embodiment shown in FIG. 2, the output V3 becomes higher level due to increase of the input detection signal VIND at the time T3. However, the exemplary embodiment of the present invention is not limited thereto, and the output V3 may be low level during a period T3 to T5.

When the control switch S1 is turned off by the low-level output V3 and thus the damper switch Q1 is turned on, resistance of the active damping circuit becomes zero resistance. In this case, the input voltage Vin is not generated, and therefore no current flows to the active damping circuit. Therefore, the resistance of the active damping circuit may have any value for a period during which the input voltage Vin is not generated.

With repetition of such an operation, the active damper 4 is operated as the damper resistor R1 during at least the firing period (T1 to T2, and T5 to T6 in FIG. 3), and is operated with zero resistance for a period during which the input voltage is generated after the firing period.

As shown in FIG. 1, after a current state is changed to the normal state by the current of the high voltage switch 400, the power voltage VDD is generated by a current supplied through the diode D3 from the auxiliary coil CO3.

However, when a dimming angle is small, the period during which the input voltage Vin is generated is very short so that energy transmitted to the secondary side is decreased. Then, the output voltage VOUT is also decreased so that a current supplied to the capacitor C2 from the auxiliary coil CO3 is also decreased.

As previously stated, during the turn-off period of the power switch M, the auxiliary voltage VA is wn2*VOUT, and therefore the auxiliary voltage VA may be decreased as the output voltage VOUT is decreased. Then, the power voltage VDD may be iteratively lower than the low voltage reference UVLO_R due to inefficiency of the power voltage.

For example, if a load coupled to an output terminal of the power supply 1 is an LED string having a plurality of LED elements coupled in series, a twinkling phenomenon of the LED string may occur.

In another exemplary embodiment of the present invention, a structure to maintain the power voltage VDD with a predetermined minimum voltage VDD_MIN using a current of the high voltage switch 400 is further included to prevent such the twinkling phenomenon.

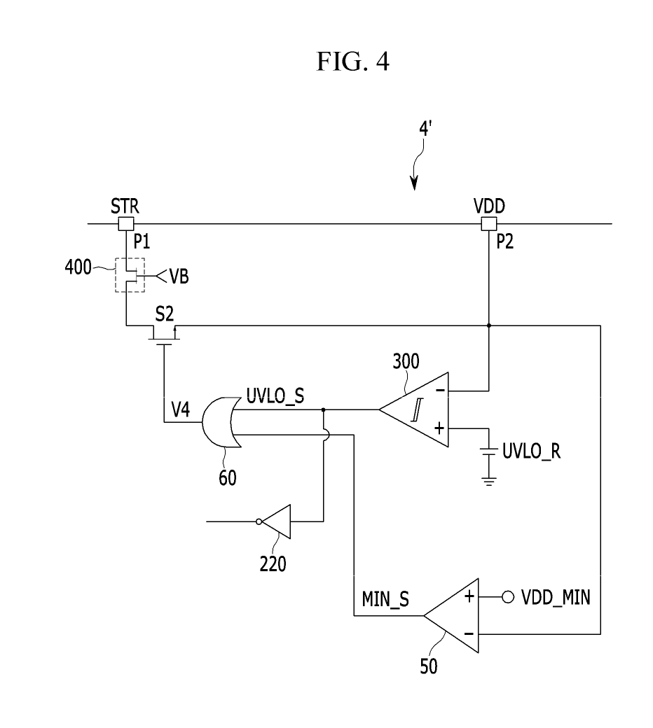

FIG. 4 shows a switch control circuit according to another exemplary embodiment of the present invention.

As shown in FIG. 4, a minimum comparator 50 compares a power voltage VDD and a minimum voltage VDD_MIN, and generates a minimum sense signal MIN_S to turn on a switch S when the power voltage VDD is lower than the minimum voltage VDD_MIN.

Compared to the previous exemplary embodiment, a switch control circuit 4′ according to the present exemplary embodiment further includes the minimum comparator 50 and an OR gate 60, in addition to the constituent elements of the switch control circuit 5. A description for the same constituent elements will be omitted.

The minimum comparator 50 includes an inverse terminal (−) to which a power voltage VDD is input and a non-inverse terminal (+) to which the minimum power VDD_MIN is input. When the input of the non-inverse terminal (+) is higher than the input of the inverse terminal (−), the minimum comparator 50 outputs a high-level minimum sense signal MIN_S and outputs a low-level minimum sense signal MIN_S in the opposite case.

The OR gate 60 performs an OR operation on an output signal UVLO_S and the minimum detection signal MIN_S to determine an output thereof. An output V4 of the OR gate 60 is transmitted to a gate electrode of the switch S2.

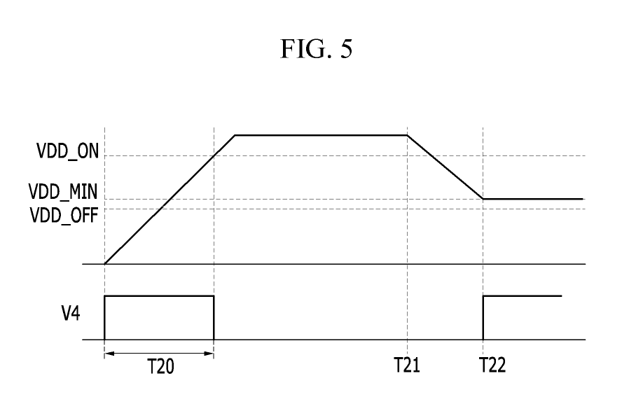

FIG. 5 is a waveform diagram of the power voltage and the output of the OR gate according to the present exemplary embodiment.

For example, during a start-up period T20, the power voltage VDD is increased by a current of the high voltage switch 400. The increasing power voltage VDD reaches the upper limit VDD_ON of a low voltage reference UVLO_R. The output V4 has high level according to a high-level output signal UVLO_R during the period T20.

After the period T20, the switch S2 is turned off, and the power voltage VDD is maintained in the normal state by a current supplied from the auxiliary coil CO3. After the period T20, the output signal UVLO_S is low level, and therefore the output V4 is also low level.

At a time T21, the power voltage VDD starts to decreased, and the power voltage VDD reaches the minimum voltage VDD_MIN at a time T22. Then, an output of the minimum comparator 50 becomes high level at the time T22 so that the output V4 becomes high level at the time T22.

Then, as shown in FIG. 5, the power voltage VDD is maintained with the minimum voltage VDD_MIN by the current of the high voltage switch 400. That is, the power voltage VDD is maintained with the minimum voltage VDD_MIN rather than being decreased to the lowest limit VDD_OFF of the low voltage reference UVLO_R.

Since the switch S2 is in the turn-on state after the time T22, no current supplied to a base of a damper switch Q1 is generated and thus the damper switch Q1 is in the turn-off state. Therefore, for a period during which the power voltage VDD is maintained with the minimum voltage VDD_MIN, the control switch S1 is turned off and thus the active damper 4 is operated as a damper resistor R1.

That is, in the previous exemplary embodiment, the switch S2 is turned on only when the power voltage VDD is lower than the low voltage reference UVLO_R, but in the other exemplary embodiment, the switch S2 is turned on when the power voltage VDD is lower than the minimum voltage VDD_MIN.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### <Description of Symbols>

power supply 1, dimmer 2

rectification circuit 3, active damper 4

switch control circuit 5, input capacitor C1

output capacitor COUT, power switch M

first coil CO1, second coil CO2, auxiliary coil CO3

damper resistor R1, resistor R2 to R4, damper switch Q1

rectification diode D2, diode D1, D3 to D5

start-up pin P1, power pin P2

sense pin P3, gate pin P4

capacitor C2, input voltage detection unit 10

active damping controller 20, gate driver 30

UVLO comparator 300, high voltage switch 400, switch S2

clamping circuit 100, current mirror circuit 110

sample/hold unit 120, sense resistor RS

comparator 130, BJT Q2, first current source 111

second current source 112

delay unit 200, OR gate 210 and 60

inverter 220, AND gate 230

control switch S1, minimum comparator 50

What is claimed is:

1. An active damping circuit of a power supply using an input voltage generated by rectifying an AC input passed through a dimmer, the active damping circuit comprising;
an active damper having a damper resistor coupled to the input voltage and a damper switch coupled in parallel with the damper resistor; and
an active damping controller configured to control a switching operation of the damper switch using a high voltage switch configured to generate a predetermined power voltage to control a resistance value of the active damper, wherein the resistance value of the active damper during a firing period of the input voltage is higher than a resistance value of the active damper during other periods of the input voltage, excluding at least the firing period among a period during which the input voltage is generated.

2. The active damping circuit of claim 1, wherein the damper switch has a control electrode coupled to a first electrode of the high voltage switch.

3. The active damping circuit of claim 2, wherein the active damper further comprises:
a first resistor coupled between a first terminal of the damper resistor and the control electrode of the damper switch; and
a first diode having an anode coupled to a second terminal of the damper resistor and a cathode coupled between control electrodes of the damper switch.

4. The active damping circuit of claim 1, wherein the active damping controller is configured to turn off the damper switch during at least the firing period and turn on the damper switch after termination of at least the firing period among the period during which the input voltage is generated.

5. The active damping circuit of claim 4, wherein the active damping controller comprises:
a delay unit configured to delay an input detection signal for a predetermined delay period, the detection signal indicating a generation period of the input voltage; and
a control switch coupled to a second electrode of the high voltage switch,
wherein, when the power voltage is higher than a predetermined low voltage reference, the active damping controller is configured to control turn-on/off of the control switch based on an output of the delay unit.

6. The active damping circuit of claim 5, wherein the active damping controller comprises:
an inverter configured to invert an output signal indicating whether the power voltage is higher than the predetermined low voltage reference:
a first logic gate configured to output a result of an OR operation performed on an output of the delay unit and the input detection signal: and a second logic gate configured to generate an output to control a switching operation of the control switch by performing an AND operation on an output of the inverter and an output of the first logic gate.

7. The active damping circuit of claim 5, wherein the predetermined delay period comprises at least the firing period.

8. An active damping method comprising:
detecting a generation period of an input voltage using an auxiliary voltage, the auxiliary voltage being generated from an auxiliary coil coupled with a predetermined turn ratio with a first coil coupled to the input voltage;
determining whether a power voltage required for controlling a switching operation of a power switch coupled to the first coil is higher than a predetermined level;
controlling a switching operation of a damper switch using a high voltage switch generating the power voltage;
controlling the active damper with a first resistance value by turning off the damper switch during at least a firing period of the input voltage among a generation period of the input voltage when the power voltage is higher than the predetermined level; and
controlling the active damper with a second resistance value by turning on the damper switch after at least the firing period among the generation period of the input voltage when the power voltage is higher than the predetermined level.

9. The active damping method of claim 8, wherein detecting the generation period of the input voltage comprises:
supplying a source current to the auxiliary coil during a turn-on period of the power switch coupled to the first coil;
generating an input sense voltage using the source current; and
generating an input detection signal indicating the generation period of the input voltage based on a result of a comparison between a sampling voltage and a predetermined reference voltage, the sampling voltage being generated by sampling the input sense voltage.

10. The active damping method of claim 9, wherein controlling the active damper with the first resistance value comprises a period during which the input detection signal and an input detection signal delayed by a predetermined period are different from one other among the generation period of the input voltage, and the predetermined period corresponds to at least the firing period.

11. The active damping method of claim 9, wherein controlling the active damper with the second resistance value comprises a period during which the input detection signal and the input detection signal delayed by the predetermined period have the same level among the generation period of the input voltage, and the predetermined period corresponds to at least the firing period.

12. The active damping method of claim 8, further comprising controlling the active damper with the first resistance value when the power voltage is lower than the predetermined level.

13. The active damping method of claim 8, wherein the first resistance value is higher than the second resistance value.

14. A power supply comprising:
an active damper having a damper resistor coupled to an input voltage and a damper switch coupled in parallel with the damper resistor, the input voltage being generated by rectifying an AC input passed through a dimmer;
a first coil having a first terminal coupled to the active damper;
a power switch coupled to a second terminal of the first coil;
an auxiliary coil coupled with a turn ratio to the first coil; and
an active damping controller configured to sense a generation period of the input voltage using an auxiliary voltage generated in the auxiliary coil and further configured to control a switching operation of the damper switch using a high voltage switch for controlling the switching operation of the power switch to control a resistance value of the active damper, wherein the resistance value of the active damper during a firing period of the input voltage is higher than a resistance value of the active damper during other periods of the input voltage, excluding at least the firing period among the generation period of the input voltage.
an active damping controller configured to control a switching operation of the damper switch using a high voltage switch configured to generate a predetermined power voltage to control a resistance value of the active damper, wherein the resistance value of the active damper during a firing period of the input voltage is higher than a resistance value of the active damper during other periods of the input voltage, excluding at least the firing period among a period during which the input voltage is generated.

15. The power supply of claim 14, wherein the damper switch has a control electrode coupled to a first electrode of the high voltage switch.

16. The power supply of claim 15, wherein the active damping controller is configured to turn off the damper switch during at least the firing period and turn on the damper switch after termination of at least the firing period during the generation period of the input voltage.

17. The power supply of claim 16, wherein the active damping controller comprises:
a delay unit configured to delay an input detection signal by a predetermined delay period, the input detection signal indicating a generation period of the input voltage; and
a control switch coupled to a second electrode of the high voltage switch,
wherein the active damping controller is configured to control the turn-on/off of the control switch based on an output of the delay unit when the power voltage is higher than a predetermined low voltage reference.

18. The power supply of claim 17, wherein the active damping controller further comprises:
an inverter configured to invert an output signal indicating whether the power voltage is higher than the predetermined low voltage reference;
a first logic gate configured to output a result of an OR operation performed on an output of the delay unit and the input detection signal; and
a second logic gate configured to generate an output for controlling a switching operation of the control switch by performing an AND operation on the output of the inverter and an output of the first logic gate.

19. The power supply of claim 15, further comprising:
a capacitor charged with the power voltage;
a switch coupled between the capacitor and a second electrode of the high voltage switch; and
a control switch having a first terminal coupled to the second electrode of the high voltage switch,
wherein the control switch is turned on during at least the firing period among the generation period of the input voltage.

20. The power supply of claim 19, further comprising a low voltage comparator configured to compare the power voltage with a predetermined low voltage reference, wherein the switch is configured to perform a switching operation based on an output of the low voltage comparator.

21. The power supply of claim 20, further comprising a comparator configured to compare the power voltage and a predetermined minimum voltage, wherein the switch is configured to perform a switching operation based on the output of the low voltage comparator and an output of the comparator.

22. The power supply of claim 21, wherein the switch is configured to be turned on when the power voltage is lower than the low voltage reference or when the power voltage is lower than the predetermined minimum voltage.
